(19) United States
(12) Patent Application Publication
(10) Pub. No.: US 2015/0288088 A1
(43) Pub. Date: Oct. 8, 2015

(54) ELECTRICAL CONNECTION UNIT AND DISPLAY DEVICE HAVING THE SAME

(71) Applicant: Samsung Display Co., LTD., Yongin-City (KR)

(72) Inventors: Kyu-Min KWON, Cheonan-si (KR); Dong-Gyoon SEO, Seoul (KR); Han-Byul LIM, Daejeon (KR); Jun-Hyuck HWANG, Asan-si (KR)

(21) Appl. No.: 14/493,113

(22) Filed: Sep. 22, 2014

(30) Foreign Application Priority Data
Apr. 3, 2014 (KR) 10-2014-0040118

(51) Int. Cl. H01R 12/78; G09G 3/36

(52) U.S. Cl. CPC H01R 12/78; G09G 3/3685; G09G 3/3696; G09G 2330/04

(57) ABSTRACT

An electrical connection unit includes a first electrical connection part and a second electrical connection part combined with the first electrical connection part. The first electrical connection part includes a first signal pin configured to transmit an electrical control signal, and a first ground pin configured to receive a ground voltage, the first ground pin being longer than the first signal pin. The second electrical connection part includes a second signal pin and a second ground pin, the second signal pin facing the first signal pin and being electrically connected to the first signal pin, the second ground pin facing the first ground pin and being electrically connected to the first ground pin. An electrical over-stress may be quickly discharged using the aforementioned electrical connection unit. Accordingly, the reliability of a display device including the electrical connection unit may be improved.

### PRIORITY STATEMENT

This application claims priority under 35 U.S.C. §119 to Korean Patent Application No. 10-2014-0040118 filed on Apr. 3, 2014, the content of which is herein incorporated by reference in its entirety.

### BACKGROUND

1. Technical Field

The present disclosure relates to an electrical connection unit and a display device including the electrical connection unit. More particularly, the present disclosure relates to an electrical connection unit including a cable and a connector, and a display device including the electrical connection unit.

2. Description of the Related Art

Generally, a display device (such as a liquid crystal display device) includes a display panel, a gate driver, a data driver, and a timing controller.

The display panel displays an image and includes a gate line and a data line.

The gate driver outputs a gate signal to the gate line of the display panel.

The data driver outputs a data signal to the data line of the display panel.

The timing controller outputs a control signal to the gate driver and the data driver for controlling operation of the display panel.

An electrical connection unit including a cable and a connector may disposed between the data driver and the timing controller to transmit the control signal.

However, when an electrical over-stress (EOS) is externally applied through the electrical connection unit, the reliability of the display device may deteriorate.

### SUMMARY

The present disclosure addresses at least the above reliability issue relating to electrical over-stress.

According to an exemplary embodiment of the inventive concept, an electrical connection unit includes a first electrical connection part and a second electrical connection part combined with the first electrical connection part. The first electrical connection part includes a first signal pin configured to transmit an electrical control signal, and a first ground pin configured to receive a ground voltage, the first ground pin being longer than the first signal pin. The second electrical connection part includes a second signal pin and a second ground pin, the second signal pin facing the first signal pin and being electrically connected to the first signal pin, the second ground pin facing the first ground pin and being electrically connected to the first ground pin.

In an embodiment, the first electrical connection part may include a cable, and the second electrical connection part may include a connector.

In an embodiment, the cable may include a cable signal pin configured to transmit the electrical control signal, and a cable ground pin configured to receive the ground voltage.

In an embodiment, the connector may include a connector signal pin electrically connected to the cable signal pin and a connector ground pin electrically connected to the cable ground pin.

In an embodiment, the connector may include a first connector combined with a first side portion of the cable, and a second connector combined with a second side portion of the cable, wherein the second side portion may be disposed opposite to the first side portion.

In an embodiment, the cable may include a first cable signal pin disposed at the first side portion and configured to transmit the electrical control signal, a first cable ground pin disposed at the first side portion and configured to receive the ground voltage, a second cable signal pin disposed at the second side portion and configured to transmit the electrical control signal and a second cable ground pin disposed at the second side portion and configured to receive the ground voltage.

In an embodiment, the first connector may include a first connector signal pin electrically connected to the first cable signal pin, and a first connector ground pin electrically connected to the first cable ground pin.

In an embodiment, the second connector may include a second connector signal pin electrically connected to the second cable signal pin and a second connector ground pin electrically connected to the second cable ground pin.

In an embodiment, the cable may be a flexible flat cable.

In an embodiment, the cable may be a flexible printed cable.

In an embodiment, the first electrical connection part may include a connector, and the second electrical connection part may include a cable.

In an embodiment, a length of the second signal pin may be substantially the same as a length of the second ground pin.

In an embodiment, the second ground pin may be longer than the second signal pin.

In an embodiment, the electrical control signal may include a control signal for controlling a display panel.

According to another exemplary embodiment of the inventive concept, a display device includes a display panel including a gate line and a data line and configured to display an image, a gate driver configured to output a gate signal to the gate line, a data driver configured to output a data signal to the data line, a timing controller configured to output a control signal to the gate driver and the data driver for controlling the display panel, and a first electrical connection unit electrically connected to the timing controller. The first electrical connection unit includes a first electrical connection part and a second electrical connection part combined with the first electrical connection part. The first electrical connection part includes a first signal pin configured to transmit the control signal, and a first ground pin longer than the first signal pin and configured to receive a ground voltage. The second electrical connection part includes a second signal pin facing the first signal pin and electrically connected to the first signal pin, and a second ground pin facing the first ground pin and electrically connected to the first ground pin.

In an embodiment, the display device may further include a second electrical connection unit connected between the timing controller and the data driver. The second electrical connection unit may include a third electrical connection part and a fourth electrical connection part combined with the third electrical connection part. The third electrical connection part may include a third signal pin configured to transmit the control signal to the data driver from the timing controller, and a third ground pin longer than the third signal pin and configured to receive the ground voltage. The fourth electrical connection part may include a fourth signal pin facing the third signal pin and electrically connected to the third signal pin, and a fourth ground pin facing the third ground pin and electrically connected to the third ground pin.

In an embodiment, the data driver may include a plurality of data driving circuits configured to output the data signal.

In an embodiment, the display device may further include a third electrical connection unit connected between the data driving circuits. The third electrical connection unit may include a fifth electrical connection part and a sixth electrical connection part combined with the fifth electrical connection part. The fifth electrical connection part may include a fifth signal pin configured to transmit the control signal to a second data driving circuit from a first data driving circuit, and a fifth ground pin longer than the fifth signal pin and configured to receive the ground voltage. The sixth electrical connection part may include a sixth signal pin facing the fifth signal pin and electrically connected to the fifth signal pin, and a sixth ground pin facing the fifth ground pin and electrically connected to the fifth ground pin.

In an embodiment, the display device may further include a fourth electrical connection unit connected between the timing controller and the gate driver. The fourth electrical connection unit may include a seventh electrical connection part and an eighth electrical connection part combined with the seventh electrical connection part. The seventh electrical connection part may include a seventh signal pin configured to transmit the control signal to the gate driver from the timing controller, and a seventh ground pin longer than the seventh signal pin and configured to receive the ground voltage. The eighth electrical connection part may include an eighth signal pin facing the seventh signal pin and electrically connected to the seventh signal pin, and an eighth ground pin facing the seventh ground pin and electrically connected to the seventh ground pin.

An electrical over-stress may be quickly discharged using one or more of the above embodiments of the electrical connection units and the display devices including the electrical connections units. Accordingly, the reliability of the display devices may be improved using the electrical connections units.

### BRIEF DESCRIPTION OF THE DRAWINGS

The above and other features and advantages will be more apparent when exemplary embodiments of the inventive concept are described with reference to the accompanying drawings.

FIG. 1 is an exploded plan view illustrating an electrical connection unit according to a first exemplary embodiment.

FIG. 2 is an exploded plan view illustrating an electrical connection unit according to a second exemplary embodiment.

FIG. 3 is an exploded plan view illustrating an electrical connection unit according to a second exemplary embodiment.

FIG. 4 is an exploded plan view illustrating an electrical connection unit according to a third exemplary embodiment.

FIG. 5 is an exploded plan view illustrating an electrical connection unit according to a fourth exemplary embodiment.

FIG. 6 is an exploded plan view illustrating an electrical connection unit according to a fifth exemplary embodiment.

FIG. 7 is a block diagram illustrating a display device according to a seventh exemplary embodiment.

### DETAILED DESCRIPTION

Exemplary embodiments will be described more fully herein with reference to the accompanying drawings in which various embodiments are shown.

### First Embodiment

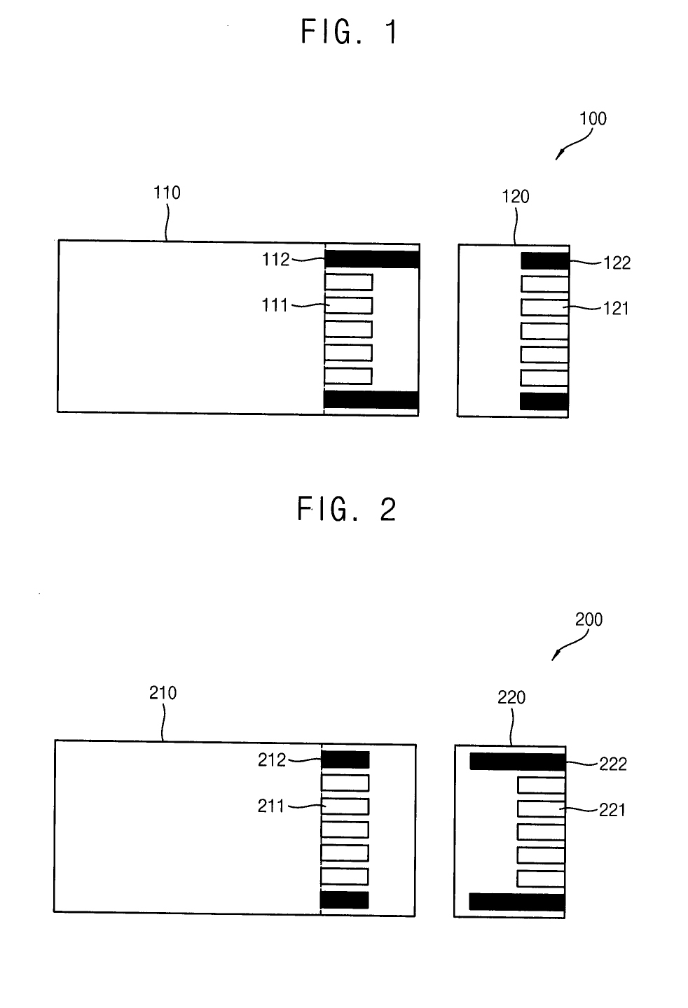

FIG. 1 is an exploded plan view illustrating an electrical connection unit according to a first exemplary embodiment.

Referring to FIG. 1, an electrical connection unit 100 includes a cable 110 and a connector 120. The cable 110 may be referred to as a first electrical connection part, and the connector 120 may be referred to as a second electrical connection part.

The cable 110 includes a cable signal pin 111 and a cable ground pin 112. In one embodiment, the cable 110 may be a flexible flat cable. In another embodiment, the cable 110 may be a flexible printed cable. The cable signal pin 111 may be referred to as a first signal pin, and the cable ground pin 112 may be referred to as a first ground pin.

The cable signal pin 111 can transmit an electrical control signal. The electrical control signal may, for example, include a control signal for controlling a display panel.

In one embodiment, the cable ground pin 112 may be longer than the cable signal pin 111. A ground voltage is applied to the cable ground pin 112.

The connector 120 can be combined with the cable 110. The connector 120 includes a connector signal pin 121 and a connector ground pin 122. The connector signal pin 121 may be referred to as a second signal pin, and the connector ground pin 122 may be referred to as a second ground pin.

The connector signal pin 121 faces the cable signal pin 111 of the cable 110, and is electrically connected to the cable signal pin 111 of the cable 110. The connector signal pin 121 may receive the electrical control signal from the cable signal pin 111 of the cable 110. In another embodiment, the connector signal pin 121 may transmit the electrical control signal to the cable signal pin 111 of the cable 110.

The connector ground pin 122 faces the cable ground pin 112 of the cable 110, and is electrically connected to the cable ground pin 112 of the cable 110. In one embodiment, a length of the connector ground pin 122 may be substantially the same as a length of the connector signal pin 121.

According to the first exemplary embodiment, when the cable 110 is combined with the connector 120, the cable ground pin 112 is electrically connected to the connector ground pin 122 before the cable signal pin 111 is electrically connected to the connector signal pin 121. Thus, an electrical over-stress that may be transmitted through the electrically connection unit 100 may be quickly discharged.

### Second Embodiment

FIG. 2 is an exploded plan view illustrating an electrical connection unit according to a second exemplary embodiment.

Referring to FIG. 2, an electrical connection unit 200 includes a cable 210 and a connector 220. The connector 220 may be referred to as a first electrical connection part, and the cable 210 may be referred to as a second electrical connection part.

The connector 220 includes a connector signal pin 221 and a connector ground pin 222. The connector signal pin 221 may be referred to as a first signal pin, and the connector ground pin 222 may be referred to as a first ground pin.

The connector signal pin 221 may receive an electrical control signal from the cable 210. In another embodiment, the connector signal pin 221 may transmit the electrical control signal to the cable 210. The electrical control signal may, for example, include a control signal for controlling a display panel.

In one embodiment, the connector ground pin 222 may be longer than the connector signal pin 221. A ground voltage is applied to the connector ground pin 222.

The cable 210 can be combined with the connector 220. The cable 210 includes a cable signal pin 211 and a cable ground pin 212. The cable signal pin 211 may be referred to as a second signal pin, and the cable ground pin 212 may be referred to as a second ground pin. In one embodiment, the cable 110 may be a flexible flat cable. In another embodiment, the cable 110 may be a flexible printed cable.

The cable signal pin 211 faces the connector signal pin 221 of the connector 220, and is electrically connected to the connector signal pin 221 of the connector 220. The cable signal pin 211 can transmit the electrical control signal.

The cable ground pin 212 faces the connector ground pin 222 of the connector 220, and is electrically connected to the connector ground pin 222 of the connector 220. In one embodiment, a length of the cable ground pin 212 may be substantially the same as a length of the cable signal pin 211.

According to the second exemplary embodiment, when the cable 210 is combined with the connector 220, the cable ground pin 212 is electrically connected to the connector ground pin 222 before the cable signal pin 211 is electrically connected to the connector signal pin 221. Thus, an electrical over-stress that may be transmitted through the electrically connection unit 200 may be quickly discharged.

### Third Embodiment

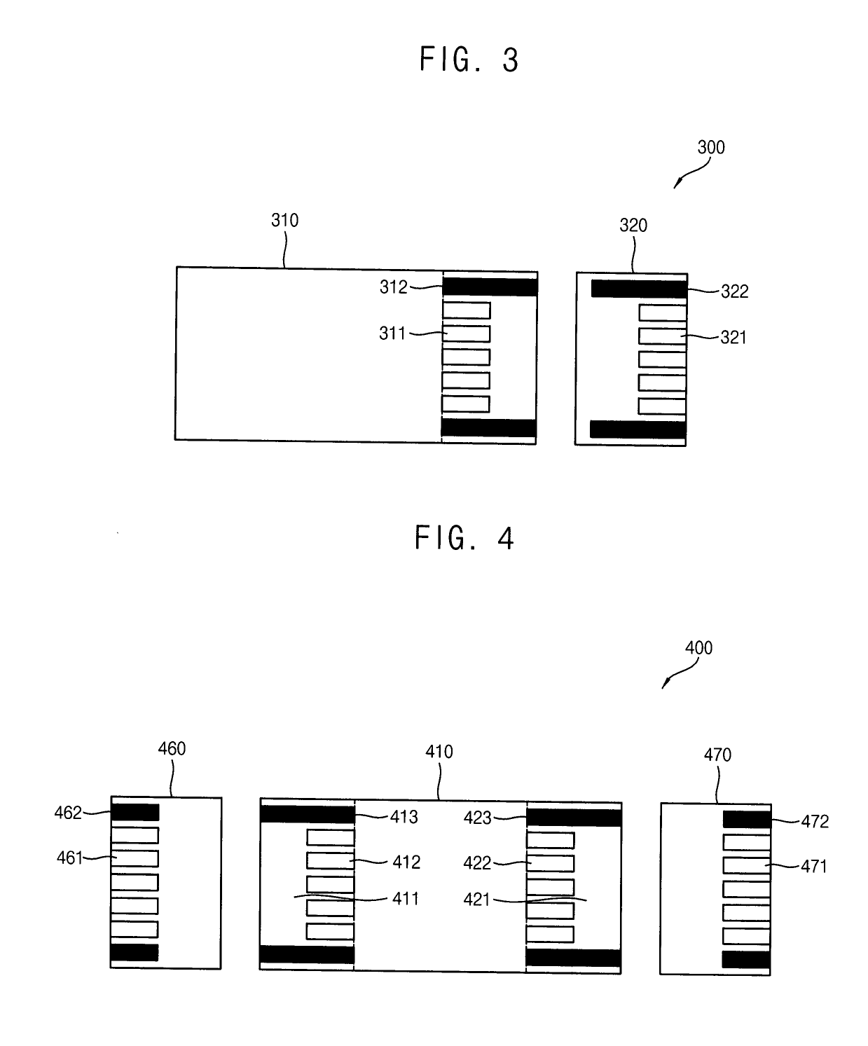

FIG. 3 is an exploded plan view illustrating an electrical connection unit according to a third exemplary embodiment.

Referring to FIG. 3, an electrical connection unit 300 includes a cable 310 and a connector 320. The cable 310 may be referred to as a first electrical connection part, and the connector 320 may be referred to as a second electrical connection part.

The cable 310 includes a cable signal pin 311 and a cable ground pin 312. In one embodiment, the cable 310 may be a flexible flat cable. In another embodiment, the cable 310 may be a flexible printed cable. The cable signal pin 311 may be referred to as a first signal pin, and the cable ground pin 312 may be referred to as a first ground pin.

The cable signal pin 311 can transmit an electrical control signal. The electrical control signal may, for example, include a control signal for controlling a display panel.

In one embodiment, the cable ground pin 312 may be longer than the cable signal pin 311. A ground voltage is applied to the cable ground pin 312.

The connector 320 can be combined with the cable 310. The connector 320 includes a connector signal pin 321 and a connector ground pin 322. The connector signal pin 321 may be referred to as a second signal pin, and the connector ground pin 322 may be referred to as a second ground pin.

The connector signal pin 321 faces the cable signal pin 311 of the cable 310, and is electrically connected to the cable signal pin 311 of the cable 310. The connector signal pin 321 may receive the electrical control signal from the cable signal pin 311 of the cable 310. In another embodiment, the connector signal pin 321 may transmit the electrical control signal to the cable signal pin 311 of the cable 310.

The connector ground pin 322 faces the cable ground pin 312 of the cable 310, and is electrically connected to the cable ground pin 312 of the cable 310. In one embodiment, the connector ground pin 322 may be longer than the connector signal pin 321.

According to the third exemplary embodiment, when the cable 310 is combined with the connector 320, the cable ground pin 312 is electrically connected to the connector ground pin 322 before the cable signal pin 311 is electrically connected to the connector signal pin 321. Thus, an electrical over-stress that may be transmitted through the electrically connection unit 300 may be quickly discharged.

### Fourth Embodiment

FIG. 4 is an exploded plan view illustrating an electrical connection unit according to a fourth exemplary embodiment.

Referring to FIG. 4, an electrical connection unit 400 includes a cable 410, a first connector 460, and a second connector 470.

The cable 410 includes a first side portion 411 and a second side portion 421 opposite to the first side portion 411. The first side portion 411 is adjacent to the first connector 460, and the second side portion 421 is adjacent to the second connector 470. In one embodiment, the cable 410 may be a flexible flat cable. In another embodiment, the cable 410 may be a flexible printed cable.

The first side portion 411 includes a first cable signal pin 412 and a first cable ground pin 413.

The first cable signal pin 412 can transmit an electrical control signal. The electrical control signal may, for example, include a control signal for controlling a display panel.

In one embodiment, the first cable ground pin 413 may be longer than the first cable signal pin 412. A ground voltage is applied to the first ground pin 413.

The second side portion 421 includes a second cable signal pin 422 and a second cable ground pin 423.

The second cable signal pin 422 can transmit an electrical control signal. The second cable signal pin 422 may be electrically connected to the first cable signal pin 412. The cable 410 may further include an inside wiring to electrically connect the first cable signal pin 412 to the second cable signal pin 422.

In one embodiment, the second cable ground pin 423 may be longer than the second cable signal pin 422. The ground voltage is applied to the second cable ground pin 423.

The first connector 460 can be combined with the first side portion 411 of the cable 410. The first connector 460 includes a first connector signal pin 461 and a first connector ground pin 462.

The first connector signal pin 461 faces the first cable signal pin 412 of the cable 410, and is electrically connected to the first cable signal pin 412 of the cable 410. The first connector signal pin 461 may receive the electrical control signal from the first cable signal pin 412 of the cable 410. In another embodiment, the first connector signal pin 461 may transmit the electrical control signal to the first cable signal pin 412 of the cable 410.

The first connector ground pin 462 faces the first cable ground pin 413 of the cable 410, and is electrically connected to the first cable ground pin 413 of the cable 410. In one embodiment, a length of the first connector ground pin 462 may be substantially the same as a length of the first connector signal pin 461.

The second connector 470 can be combined with the second side portion 421 of the cable 410. The second connector 470 includes a second connector signal pin 471 and a second connector ground pin 472.

The second connector signal pin 471 faces the second cable signal pin 422 of the cable 420, and is electrically connected to the second cable signal pin 422 of the cable 410. The second connector signal pin 471 may receive the electrical control signal from the second cable signal pin 422 of the cable 410. In another embodiment, the second connector signal pin 471 may transmit the electrical control signal to the second cable signal pin 422 of the cable 410.

The second connector ground pin 472 faces the second cable ground pin 423 of the cable 410, and is electrically connected to the second cable ground pin 423 of the cable 410. In one embodiment, a length of the second connector ground pin 472 may be substantially the same as a length of the second connector signal pin 471.

According to the fourth exemplary embodiment, when the cable 410 is combined with the first connector 460, the first cable ground pin 413 is electrically connected to the first connector ground pin 462 before the first cable signal pin 412 is electrically connected to the first connector signal pin 461. Furthermore, when the cable 410 is combined with the second connector 470, the second cable ground pin 423 is electrically connected to the second connector ground pin 472 before the second cable signal pin 422 is electrically connected to the second connector signal pin 471. Thus, an electrical over-stress that may be transmitted through the electrically connection unit 400 may be quickly discharged.

### Fifth Embodiment

FIG. 5 is an exploded plan view illustrating an electrical connection unit according to a fifth exemplary embodiment.

Referring to FIG. 5, an electrical connection unit 500 includes a cable 510, a first connector 560, and a second connector 570.

The cable 510 includes a first side portion 511 and a second side portion 521. The first side portion 511 is adjacent to the first connector 560, and the second side portion 521 is adjacent to the second connector 570. In one embodiment, the cable 510 may be a flexible flat cable. In another embodiment, the cable 510 may be a flexible printed cable.

The first side portion 511 includes a first cable signal pin 512 and a first cable ground pin 513.

The first cable signal pin 512 can transmit an electrical control signal. The electrical control signal may, for example, include a control signal for controlling a display panel.

In one embodiment, a length of the first cable ground pin 513 may be substantially the same as a length of the first cable signal pin 512. A ground voltage is applied to the first ground pin 513.

The second side portion 521 includes a second cable signal pin 522 and a second cable ground pin 523.

The second cable signal pin 522 can transmit the electrical control signal. The second cable signal pin 522 may be electrically connected to the first cable signal pin 512. The cable 510 may further include an inside wiring to electrically connect the first cable signal pin 512 to the second cable signal pin 522.

In one embodiment, a length of the second cable ground pin 523 may be substantially the same as a length of the second cable signal pin 522. The ground voltage is applied to the second cable ground pin 523.

The first connector 560 can be combined with the first side portion 511 of the cable 510. The first connector 560 includes a first connector signal pin 561 and a first connector ground pin 562.

The first connector signal pin 561 faces the first cable signal pin 512 of the cable 510, and is electrically connected to the first cable signal pin 512 of the cable 510. The first connector signal pin 561 may receive the electrical control signal from the first cable signal pin 512 of the cable 510. In another embodiment, the first connector signal pin 561 may transmit the electrical control signal to the first cable signal pin 512 of the cable 510.

The first connector ground pin 562 faces the first cable ground pin 513 of the cable 510, and is electrically connected to the first cable ground pin 513 of the cable 510. In one embodiment, the first connector ground pin 562 may be longer than the first connector signal pin 561.

The second connector 570 can be combined with the second side portion 521 of the cable 510. The second connector 570 includes a second connector signal pin 571 and a second connector ground pin 572.

The second connector signal pin 571 faces the second cable signal pin 522 of the cable 520, and is electrically connected to the second cable signal pin 522 of the cable 510. The second connector signal pin 571 may receive the electrical control signal from the second cable signal pin 522 of the cable 510. In another embodiment, the second connector signal pin 571 may transmit the electrical control signal to the second cable signal pin 522 of the cable 510.

The second connector ground pin 572 faces the second cable ground pin 523 of the cable 510, and is electrically connected to the second cable ground pin 523 of the cable 510. In one embodiment, a length of the second connector ground pin 572 may be substantially the same as a length of the second connector signal pin 571.

According to the fifth exemplary embodiment, when the cable 510 is combined with the first connector 560, the first cable ground pin 513 is electrically connected to the first connector ground pin 562 before the first cable signal pin 512 is electrically connected to the first connector signal pin 561. Furthermore, when the cable 510 is combined with the second connector 570, the second cable ground pin 523 is electrically connected to the second connector ground pin 572 before the second cable signal pin 522 is electrically connected to the second connector signal pin 571. Thus, an electrical over-stress that may be transmitted through the electrically connection unit 500 may be quickly discharged.

### Sixth Embodiment

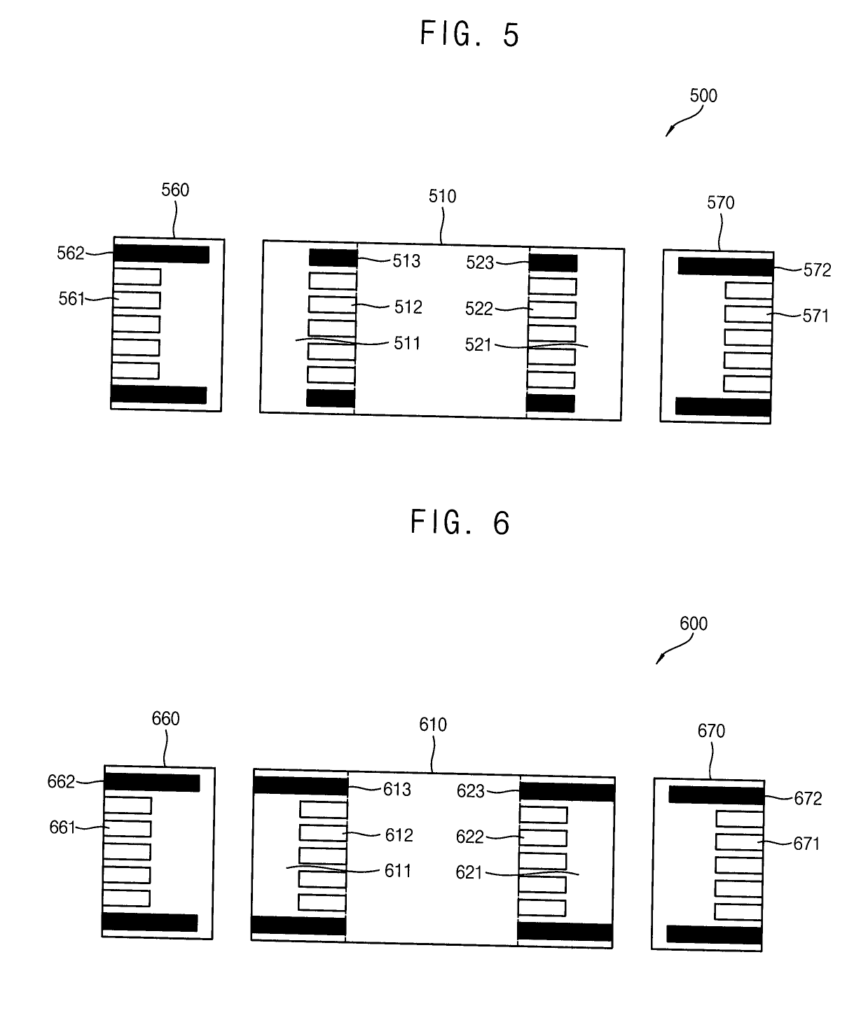

FIG. 6 is an exploded plan view illustrating an electrical connection unit according to a sixth exemplary embodiment.

Referring to FIG. 6, an electrical connection unit 600 includes a cable 610, a first connector 660, and a second connector 670.

The cable 610 includes a first side portion 611 and a second side portion 621. The first side portion 611 is adjacent to the first connector 660, and the second side portion 621 is adjacent to the second connector 670. In one embodiment, the cable 610 may be a flexible flat cable. In another embodiment, the cable 610 may be a flexible printed cable.

The first side portion 611 includes a first cable signal pin 612 and a first cable ground pin 613.

The first cable signal pin 612 can transmit an electrical control signal. The electrical control signal may, for example, include a control signal for controlling a display panel.

In one embodiment, the first cable ground pin 613 may be longer than the first cable signal pin 612. A ground voltage is applied to the first ground pin 613.

The second side portion 621 includes a second cable signal pin 622 and a second cable ground pin 623.

The second cable signal pin 622 can transmit the electrical control signal. The second cable signal pin 622 may be electrically connected to the first cable signal pin 612. The cable 610 may further include an inside wiring to electrically connect the first cable signal pin 612 to the second cable signal pin 622.

In one embodiment, the second cable ground pin 623 may be longer than the second cable signal pin 622. The ground voltage is applied to the second cable ground pin 623.

The first connector 660 can be combined with the first side portion 611 of the cable 610. The first connector 660 includes a first connector signal pin 661 and a first connector ground pin 662.

The first connector signal pin 661 faces the first cable signal pin 612 of the cable 610, and is electrically connected to the first cable signal pin 612 of the cable 610. The first connector signal pin 661 may receive the electrical control signal from the first cable signal pin 612 of the cable 610. In another embodiment, the first connector signal pin 661 may transmit the electrical control signal to the first cable signal pin 612 of the cable 610.

The first connector ground pin 662 faces the first cable ground pin 613 of the cable 610, and is electrically connected to the first cable ground pin 613 of the cable 610. In one embodiment, the first connector ground pin 662 may be longer than the first connector signal pin 661.

The second connector 670 can be combined with the second side portion 621 of the cable 610. The second connector 670 includes a second connector signal pin 671 and a second connector ground pin 672.

The second connector signal pin 671 faces the second cable signal pin 622 of the cable 620, and is electrically connected to the second cable signal pin 622 of the cable 610. The second connector signal pin 671 may receive the electrical control signal from the second cable signal pin 622 of the cable 610. In another embodiment, the second connector signal pin 671 may transmit the electrical control signal to the second cable signal pin 622 of the cable 610.

The second connector ground pin 672 faces the second cable ground pin 623 of the cable 610, and is electrically connected to the second cable ground pin 623 of the cable 610. In one embodiment, the second connector ground pin 672 may be longer than the second connector signal pin 671.

According to the sixth exemplary embodiment, when the cable 610 is combined with the first connector 660, the first cable ground pin 613 is electrically connected to the first connector ground pin 662 before the first cable signal pin 612 is electrically connected to the first connector signal pin 661. Furthermore, when the cable 610 is combined with the second connector 670, the second cable ground pin 623 is electrically connected to the second connector ground pin 672 before the second cable signal pin 622 is electrically connected to the second connector signal pin 671. Thus, an electrical over-stress that may be transmitted through the electrically connection unit 600 may be quickly discharged.

### Seventh Embodiment

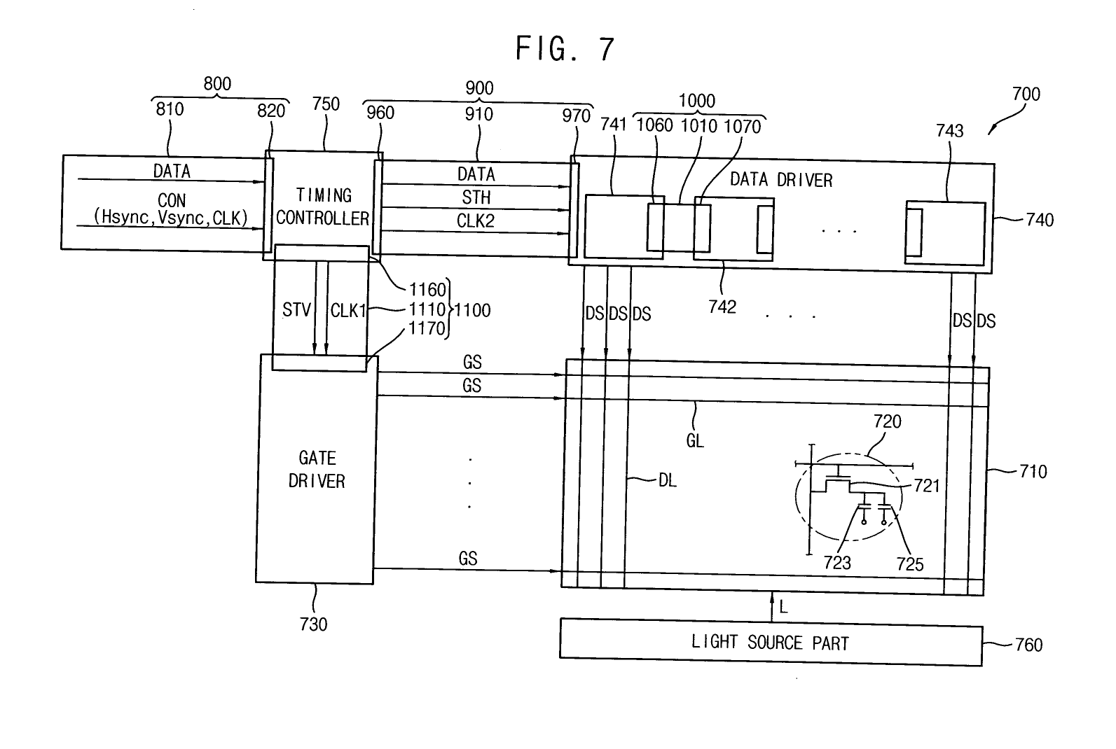

FIG. 7 is a block diagram illustrating a display device according to a seventh exemplary embodiment.

Referring to FIG. 7, a display device 700 includes a display panel 710, a gate driver 730, a data driver 740, a timing controller 750, a light source part 760, a first electrical connection unit 800, a second electrical connection unit 900, a third electrical connection unit 1000, and a fourth electrical connection unit 1100. The gate driver 730, the data driver 740, and the timing controller 750 collectively constitute a display panel driving device for controlling the display panel 710.

The display panel 710 receives a data signal DS based on image data DATA provided from the timing controller 750 to display an image. The image data DATA may, for example, include two-dimensional image data. Alternatively, the image data DATA may include left-eye image data and right-eye image data for displaying a three-dimensional image.

The display panel 710 includes a plurality of gate lines GL, a plurality of data lines DL, and a plurality of pixels 720. The gate line GL extends in a first direction. The data line DL extends in a second direction perpendicular to the first direction. Each of the pixels 720 includes a thin film transistor 721 electrically connected to the gate line GL and the data line DL, a liquid crystal capacitor 723 connected to the thin film transistor 721, and a storage capacitor 725.

The gate driver 730 generates a gate signal GS in response to a gate start signal STV and a gate clock signal CLK1, which are provided from the timing controller 750, and outputs the gate signal GS to the gate line GL.

The data driver 740 generates a data signal DS in response to a data start signal STH and a data clock signal CLK2, which are provided from the timing controller 750, and outputs the data signal DS to the data line DL. For example, the data driver 740 includes a plurality of data driving circuits 741, 742, and 743, which output at least one data signal DS. For example, the data driver 740 may include a first data driver 741, a second data driver 742, and an M-th data driver 743.

The timing controller 750 receives the image data DATA and a control signal CON from an external device. The control signal CON controls operation of the display panel 710 and may include a horizon synchronization signal Hsync, a vertical synchronization signal Vsync, and a clock signal CLK. The timing controller 750 uses the horizon synchronization signal Hsync to generate the data start signal STH, and outputs the data start signal STH to the data driver 740. Furthermore, the timing controller 750 uses the vertical synchronization signal Vsync to generate the gate start signal STV, and outputs the gate start signal STV to the gate driver 730. Furthermore, the timing controller 750 uses the clock signal CLK to generate the gate clock signal CLK1 and the data clock signal CLK2, and outputs the gate clock signal CLK1 to the gate driver 730 and outputs the data clock signal CLK2 to the data driver 740.

The light source part 760 provides a light L to the display panel 710. The light source part 760 may, for example, include a light emitting diode LED.

The first electrical connection unit 800 connects the timing controller 750 to the external device. The first electrical connection unit 800 includes a cable 810 and a connector 820. The cable 810 may be referred to as a first electrical connection part, and the connector 820 may be referred to as a second electrical connection part. In another embodiment, the connector 820 may be referred to as a first electrical connection part, and the cable 810 may be referred to as a second electrical connection part.

The cable 810 is connected between the external device and the timing controller 750, and transmits the image data DATA and the control signal CON to the timing controller 750 from the external device. The connector 820 is combined with the timing controller 750, and receives the image data DATA and the control signal CON from the cable 810.

In one embodiment, the first electrical connection unit 800 may be substantially the same as the electrical connection unit 100 illustrated in FIG. 1. Thus, the cable 810 and the connector 820 of the first electrical connection unit 800 may be substantially the same as the respective cable 110 and the connector 120 of the electrical connection unit 100.

In another embodiment, the first electrical connection unit 800 may be substantially the same as the electrical connection unit 200 illustrated in FIG. 2. Thus, the cable 810 and the connector 820 of the first electrical connection unit 800 may be substantially the same as the respective cable 210 and the connector 220 of the electrical connection unit 200.

In another embodiment, the first electrical connection unit 800 may be substantially the same as the electrical connection unit 300 illustrated in FIG. 3. Thus, the cable 810 and the connector 820 of the first electrical connection unit 800 may be substantially the same as the respective cable 310 and the connector 320 of the electrical connection unit 300.

The second electrical connection unit 900 electrically connects the timing controller 750 and the data driver 740. The second electrical connection unit 900 includes a cable 910, a first connector 960, and a second connector 970. The cable 910 may be referred to as a third electrical connection part, and the first and second connectors 960 and 970 may be referred to as a fourth electrical connection part. Alternatively, the first and second connectors 960 and 970 may be referred to as a third electrical connection part, and the cable 910 may be referred to as a fourth electrical connection part.

The cable 910 is connected between the timing controller 750 and the data driver 740, and transmits the image data DATA, the data start signal STH, and the data clock signal CLK2 to the data driver 740 from the timing controller 750. The first connector 960 is combined with the timing controller 750, and receives the image data DATA, the data start signal STH, and the data clock signal CLK2 from the timing controller 750. The second connector 970 is combined with the data driver 740, and transmits the image data DATA, the data start signal STH, and the data clock signal CLK2 to the data driver 740 from the cable 910.

The second electrical connection unit 900 may be substantially the same as the electrical connection unit 400 illustrated in FIG. 4. Thus, the cable 910, the first connector 960, and the second connector 970 of the second electrical connection unit 900 may be substantially the same as the respective cable 410, the first connector 460, and the second connector 470 of the electrical connection unit 400.

In another embodiment, the second electrical connection unit 900 may be substantially the same as the electrical connection unit 500 illustrated in FIG. 5. Thus, the cable 910, the first connector 960, and the second connector 970 of the second electrical connection unit 900 may be substantially the same as the respective cable 510, the first connector 560, and the second connector 570 of the electrical connection unit 500.

In another embodiment, the second electrical connection unit 900 may be substantially the same as the electrical connection unit 600 illustrated in FIG. 6. Thus, the cable 910, the first connector 960, and the second connector 970 of the second electrical connection unit 900 may be substantially the same as the respective cable 610, the first connector 660, and the second connector 670 of the electrical connection unit 600.

The third electrical connection unit 1000 electrically connects the data driving circuits 741, 742, and 743 to each other. For example, the third electrical connection unit 1000 may electrically connect the first data driving circuit 741 to the second data driving circuit 742. The third electrical connection unit 1000 includes a cable 1010, a first connector 1060, and a second connector 1070. The cable 1010 may be referred to as a fifth electrical connection part, and the first and second connectors 1060 and 1070 may be referred to as a sixth electrical connection part. Alternatively, the first and second connectors 1060 and 1070 may be referred to as a fifth electrical connection part, and the cable 1010 may be referred to as a sixth electrical connection part.

The cable 1010 is connected between the first data driving circuit 741 and the second data driving circuit 742, and transmits the data start signal STH to the second data driving circuit 742 from the first data driving circuit 741. The first connector 1060 is combined with the first data driving circuit 741, and receives the data start signal STH from the first data driving circuit 741. The second connector 1070 is combined with the second data driving circuit 742, and transmits the data start signal STH to the data driving circuit 742 from the cable 1010.

The third electrical connection unit 1000 may be substantially the same as the electrical connection unit 400 illustrated in FIG. 4. Thus, the cable 1010, the first connector 1060, and the second connector 1070 of the third electrical connection unit 1000 may be substantially the same as the respective cable 410, the first connector 460, and the second connector 470 of the electrical connection unit 400.

In another embodiment, the third electrical connection unit 1000 may be substantially the same as the electrical connection unit 500 illustrated in FIG. 5. Thus, the cable 1010, the first connector 1060, and the second connector 1070 of the third electrical connection unit 1000 may be substantially the same as the respective cable 510, the first connector 560, and the second connector 570 of the electrical connection unit 500.

In another embodiment, the third electrical connection unit 1000 may be substantially the same as the electrical connection unit 600 illustrated in FIG. 6. Thus, the cable 1010, the first connector 1060, and the second connector 1070 of the third electrical connection unit 1000 may be substantially the same as the respective cable 610, the first connector 660, and the second connector 670 of the electrical connection unit 600.

The fourth electrical connection unit 1100 electrically connects the timing controller 750 to the gate driver 730. The fourth electrical connection unit 1100 includes a cable 1110, a first connector 1160, and a second connector 1170. The cable 1110 may be referred to as a seventh electrical connection part, and the first and second connectors 1160 and 1170 may be referred to as an eighth electrical connection part. Alternatively, the first and second connectors 1160 and 1170 may be referred to as a seventh electrical connection part, and the cable 1110 may be referred to as an eighth electrical connection part.

The cable 1110 is connected between the timing controller 750 and the gate driver 730, and transmits the gate start signal STV and the gate clock signal CLK1 to the gate driver 730 from the timing controller 750. The first connector 1160 is combined with the timing controller 750, and receives the gate start signal STV and the gate clock signal CLK1 from the timing controller 750. The second connector 1170 is combined with the gate driver 730, and transmits the gate start signal STV and the gate clock signal CLK1 to the data driver 740 from the cable 1110.

The fourth electrical connection unit 1100 may be substantially the same as the electrical connection unit 400 illustrated in FIG. 4. Thus, the cable 1110, the first connector 1160, and the second connector 1170 of the second electrical connection unit 1100 may be substantially the same as the respective cable 410, the first connector 460, and the second connector 470 of the electrical connection unit 400.

In another embodiment, the fourth electrical connection unit 1100 may be substantially the same as the electrical connection unit 500 illustrated in FIG. 5. Thus, the cable 1110, the first connector 1160, and the second connector 1170 of the second electrical connection unit 1100 may be substantially the same as the respective cable 510, the first connector 560, and the second connector 570 of the electrical connection unit 500.

In another embodiment, the fourth electrical connection unit 1100 may be substantially the same as the electrical connection unit 600 illustrated in FIG. 6. Thus, the cable 1110, the first connector 1160, and the second connector 1170 of the second electrical connection unit 1100 may be substantially the same as the respective cable 610, the first connector 660, and the second connector 670 of the electrical connection unit 600.

According to the above-described exemplary embodiments, an electrical over-stress that may be transmitted through the first electrical connection unit 800, the second electrical connection unit 900, the third electrical connection unit 1000 and the fourth electrical connection unit 1100 may be quickly discharged. Thus, reliability of the display device 700 may be improved.

According to the above electrical connection units and the display devices including the electrical connections units, an electrical over-stress may be quickly discharged. Thus, reliability of the display devices may be improved.

The foregoing description is merely illustrative of the inventive concept and should not be construed as limiting the inventive concept. Although a few exemplary embodiments have been described, those skilled in the art will readily appreciate that modifications can be made to the exemplary embodiments without departing from the novel teachings, aspects, and advantages of the inventive concept. Accordingly, all such modifications are intended to be included within the scope of this disclosure.

What is claimed is:

1. An electrical connection unit comprising:
a first electrical connection part including a first signal pin configured to transmit an electrical control signal, and a first ground pin configured to receive a ground voltage, the first ground pin being longer than the first signal pin; and
a second electrical connection part combined with the first electrical connection part and including a second signal pin and a second ground pin, the second signal pin facing the first signal pin and being electrically connected to the first signal pin, the second ground pin facing the first ground pin and being electrically connected to the first ground pin.

2. The electrical connection unit of claim 1, wherein the first electrical connection part includes a cable, and the second electrical connection part includes a connector.

3. The electrical connection unit of claim 2, wherein the cable includes:
a cable signal pin configured to transmit the electrical control signal; and
a cable ground pin configured to receive the ground voltage.

4. The electrical connection unit of claim 3, wherein the connector includes:
a connector signal pin electrically connected to the cable signal pin; and
a connector ground pin electrically connected to the cable ground pin.

5. The electrical connection unit of claim 2, wherein the connector includes:
a first connector combined with a first side portion of the cable; and
a second connector combined with a second side portion of the cable, wherein the second side portion is disposed opposite to the first side portion.

6. The electrical connection unit of claim 5, wherein the cable includes:
a first cable signal pin disposed at the first side portion and configured to transmit the electrical control signal;
a first cable ground pin disposed at the first side portion and configured to receive the ground voltage;
a second cable signal pin disposed at the second side portion and configured to transmit the electrical control signal; and
a second cable ground pin disposed at the second side portion and configured to receive the ground voltage.

7. The electrical connection unit of claim 6, wherein the first connector includes:
a first connector signal pin electrically connected to the first cable signal pin; and
a first connector ground pin electrically connected to the first cable ground pin.

8. The electrical connection unit of claim 7, wherein the second connector includes:
a second connector signal pin electrically connected to the second cable signal pin; and
a second connector ground pin electrically connected to the second cable ground pin.

9. The electrical connection unit of claim 2, wherein the cable is a flexible flat cable.

10. The electrical connection unit of claim 2, wherein the cable is a flexible printed cable.

11. The electrical connection unit of claim 1, wherein the first electrical connection part includes a connector, and the second electrical connection part includes a cable.

12. The electrical connection unit of claim 1, wherein a length of the second signal pin is substantially the same as a length of the second ground pin.

13. The electrical connection unit of claim 1, wherein the second ground pin is longer than the second signal pin.

14. The electrical connection unit of claim 1, wherein the electrical control signal includes a control signal for controlling a display panel.

15. A display device comprising:
a display panel including a gate line and a data line and configured to display an image;
a gate driver configured to output a gate signal to the gate line;
a data driver configured to output a data signal to the data line;
a timing controller configured to output a control signal to the gate driver and the data driver for controlling the display panel; and
a first electrical connection unit electrically connected to the timing controller and including a first electrical connection part and a second electrical connection part combined with the first electrical connection part, the first electrical connection part including a first signal pin configured to transmit the control signal, and a first ground pin longer than the first signal pin and configured to receive a ground voltage, the second electrical connection part including a second signal pin facing the first signal pin and electrically connected to the first signal pin, and a second ground pin facing the first ground pin and electrically connected to the first ground pin.

16. The display device of claim 15, further comprising a second electrical connection unit connected between the timing controller and the data driver, the second electrical connection unit including a third electrical connection part and a fourth electrical connection part combined with the third electrical connection part, the third electrical connection part including a third signal pin configured to transmit the control signal to the data driver from the timing controller, and a third ground pin longer than the third signal pin and configured to receive the ground voltage, the fourth electrical connection part including a fourth signal pin facing the third signal pin and electrically connected to the third signal pin, and a fourth ground pin facing the third ground pin and electrically connected to the third ground pin.

17. The display device of claim 15, wherein the data driver includes a plurality of data driving circuits configured to output the data signal.

18. The display device of claim 17, further comprising a third electrical connection unit connected between the data driving circuits, the third electrical connection unit including a fifth electrical connection part and a sixth electrical connection part combined with the fifth electrical connection part, the fifth electrical connection part including a fifth signal pin configured to transmit the control signal to a second data driving circuit from a first data driving circuit, and a fifth ground pin longer than the fifth signal pin and configured to receive the ground voltage, the sixth electrical connection part including a sixth signal pin facing the fifth signal pin and electrically connected to the fifth signal pin, and a sixth ground pin facing the fifth ground pin and electrically connected to the fifth ground pin.

19. The display device of claim 15, further comprising a fourth electrical connection unit connected between the timing controller and the gate driver, the fourth electrical connection unit including a seventh electrical connection part and an eighth electrical connection part combined with the seventh electrical connection part, the seventh electrical connection part including a seventh signal pin configured to transmit the control signal to the gate driver from the timing controller, and a seventh ground pin longer than the seventh signal pin and configured to receive the ground voltage, the eighth electrical connection part including an eighth signal pin facing the seventh signal pin and electrically connected to the seventh signal pin, and an eighth ground pin facing the seventh ground pin and electrically connected to the seventh ground pin.
